(19) United States
(12) Patent Application Publication
(10) Pub. No.: US 2026/0186271 A1
(43) Pub. Date: Jul. 2, 2026

(54) CAMERA OPTICAL LENS

(71) Applicant: Changzhou AAC Raytech Optronics Co., Ltd., Changzhou City (CN)

(72) Inventors: Yongqiang Yang, Changzhou (CN); Shunda Zhou, Changzhou (CN)

(21) Appl. No.: 19/430,168

(22) Filed: Dec. 22, 2025

Related U.S. Application Data
(63) Continuation of application No. PCT/CN2025/128787, filed on Oct. 20, 2025.

(30) Foreign Application Priority Data
Dec. 26, 2024 (WO) PCT/CN2024/142665

(51) Int. Cl. G02B 13/00; G02B 9/16; G02B 17/08

(52) U.S. Cl. CPC G02B 13/0065; G02B 9/16; G02B 13/004; G02B 17/08

(57) ABSTRACT

Provided is a camera optical lens, including five lenses and a prism. Focal length and total track length of the camera optical lens are f and TTL, focal length of the first lens is f1, combined focal length of the first and second lenses is f12, combined focal length of the second, third and fourth lenses is f234, central curvature radii of the first lens at the object side and image side surfaces are R1 and R2, on-axis thickness of the first lens and the third lens are d1 and d5, and on-axis distance from the object side surface of the first lens to the image side surface of the fourth lens is Td, distance between maximum effective aperture of object and image side surfaces of the third lens is ET3, following relational expressions are satisfied: 0.30≤f1/f≤0.70; −1.40≤f12/f234≤−0.426; −3.00≤R1/R2≤−1.00; 0.16≤Td/TTL≤0.21; and 0.05≤d5/ET3≤0.66. The camera optical lens has excellent optical characteristics.

### TECHNICAL FIELD

The present disclosure relates to the field of optical lenses, and in particular, to a camera optical lens suitable for handheld terminal devices such as smart phones and digital cameras, and camera apparatus such as monitors and PC lenses.

### BACKGROUND

In recent years, with the rise of various smart devices, the demand for a miniaturized camera optical lens has gradually increased. Since the pixel size of a photosensitive device is reduced, and the current electronic product has a development trend towards having good functions and an appearance of thin, light and portable, the miniaturized camera optical lens having good imaging quality has become a mainstream in the current market. In order to obtain better imaging quality, a multi-lens structure is mostly adopted. In addition, with the development of technology and the increase of diversified requirements of users, under the conditions that a pixel area of the photosensitive device continues to shrink and the requirement on the imaging quality of the system are continuously improving, a structure combining lenses and prisms has been gradually adopted in the lens design. There is an urgent need for a periscope long-focus camera optical lens having excellent optical characteristics with small volume and fully corrected aberrations.

### SUMMARY

In view of the above problems, a main object of the present disclosure is to provide a camera optical lens, which has good optical performance and meets design requirements of long focus and miniaturization.

In order to achieve the above object, the technical solution of the present disclosure provides a camera optical lens, including from an object side to an image side: a first lens having a positive refractive power, a second lens having a negative refractive power, a third lens having a negative refractive power, a fourth lens having a positive refractive power, and a prism having a reflective power. The prism includes along an optical axis: a first transmissive surface, a first reflective surface, a second reflective surface, a third reflective surface and a second transmissive surface. The first transmissive surface, the second reflective surface and the second transmissive surface are parallel to each other. A focal length of the camera optical lens is f, a focal length of the first lens is f1, a combined focal length of the first lens and the second lens is f12, a combined focal length of the second lens, the third lens and the fourth lens is f234, a central curvature radius of an object side surface of the first lens is R1, a central curvature radius of an image side surface of the first lens is R2, an on-axis thickness of the third lens is d5, a distance from a maximum effective aperture of an object side surface of the third lens to a maximum effective aperture of an image side surface of the third lens in a direction parallel to the optical axis is ET3, an on-axis distance from the object side surface of the first lens to an image side surface of the fourth lens is Td, a total track length of the camera optical lens is TTL, and following relational expressions are satisfied: 0.30≤f1/f≤0.70; −1.40≤f12/f234≤−0.426; −3.00≤R1/R2≤−1.00; 0.16≤Td/TTL≤0.21; and 0.05≤d5/ET3≤0.66.

As an improvement, an on-axis thickness of the fourth lens is d7, and a following relational expression is satisfied: 0.70≤d5/d7≤0.80.

As an improvement, the camera optical lens further satisfies a following relational expression: 2.7≤(R1−R2)/f1≤3.20.

As an improvement, the object side surface of the first lens is convex in a paraxial region, and the image side surface of the first lens is convex in the paraxial region. An on-axis thickness of the first lens is d1, and a following relational expression is satisfied: 0.046≤d1/TTL≤0.051.

As an improvement, an image side surface of the second lens is concave in a paraxial region. A focal length of the second lens is f2, a central curvature radius of an object side surface of the second lens is R3, a central curvature radius of the image side surface of the second lens is R4, and an on-axis thickness of the second lens is d3, and following relational expressions are satisfied: −1.94≤f2/f≤−0.58; −0.68≤(R3+R4)/(R3−R4)≤8.29; and 0.016≤d3/TTL≤0.034.

As an improvement, a focal length of the third lens is f3, a central curvature radius of the object side surface of the third lens is R5, and a central curvature radius of the image side surface of the third lens is R6, and following relational expressions are satisfied: −0.90≤f3/f≤−0.41; −5.51≤(R5+R6)/(R5−R6)≤1.34; and 0.018≤d5/TTL≤0.024.

As an improvement, an image side surface of the fourth lens is convex in a paraxial region. A focal length of the fourth lens is f4, a central curvature radius of an object side surface of the fourth lens is R7, a central curvature radius of the image side surface of the fourth lens is R8, and an on-axis thickness of the fourth lens is d7, and following relational expressions are satisfied: 0.72≤f4/f≤1.02; 0.97≤(R7+R8)/(R7−R8)≤2.39; and 0.024≤d7/TTL≤0.030.

As an improvement, a ratio of a focal length of the camera optical lens to an entrance pupil diameter is FNO, and a following relational expressions is satisfied: FNO≤2.90.

As an improvement, an image height of the camera optical lens is IH, and a following relational expressions is satisfied: TTL/IH≤5.26.

As an improvement, the prism and/or the first lens are made of glass.

The present disclosure has the following beneficial effects: the camera optical lens according to the present disclosure has excellent optical characteristics, as well as long focus and miniaturization characteristics, and is particularly suitable for a mobile phone camera optical lens assembly and a WEB camera optical lens composed of camera elements such as CCD and CMOS with high resolution.

### BRIEF DESCRIPTION OF DRAWINGS

In order to better illustrate the technical solutions in embodiments of the present disclosure, the drawings required to be used in the description of the embodiments will be briefly described below. It is appreciated that, the drawings in the following description are only some embodiments of the present disclosure, and for those skilled in the art, other drawings may also be obtained according to these drawings without creative effort.

FIG. 1 is a schematic structural diagram of a camera optical lens according to a first embodiment of the present disclosure;

FIG. 2 is a schematic diagram of propagation of multiple light beams in the camera optical lens shown in FIG. 1;

FIG. 3 is a schematic diagram of longitudinal aberration of the camera optical lens shown in FIG. 1;

FIG. 4 is a schematic diagram of lateral color of the camera optical lens shown in FIG. 1;

FIG. 5 is a schematic diagram of field curvature and distortion of the camera optical lens shown in FIG. 1;

FIG. 6 is a schematic structural diagram of a camera optical lens according to a second embodiment of the present disclosure;

FIG. 7 is a schematic diagram of propagation of multiple light beams in the camera optical lens shown in FIG. 6;

FIG. 8 is a schematic diagram of longitudinal aberration of the camera optical lens shown in FIG. 6;

FIG. 9 is a schematic diagram of lateral color of the camera optical lens shown in FIG. 6;

FIG. 10 is a schematic diagram of field curvature and distortion of the camera optical lens shown in FIG. 6;

FIG. 11 is a schematic structural diagram of a camera optical lens according to a third embodiment of the present disclosure;

FIG. 12 is a schematic diagram of propagation of multiple light beams in the camera optical lens shown in FIG. 11;

FIG. 13 is a schematic diagram of longitudinal aberration of the camera optical lens shown in FIG. 11;

FIG. 14 is a schematic diagram of lateral color of the camera optical lens shown in FIG. 11;

FIG. 15 is a schematic diagram of field curvature and distortion of the camera optical lens shown in FIG. 11;

FIG. 16 is a schematic structural diagram of a camera optical lens according to a fourth embodiment of the present disclosure;

FIG. 17 is a schematic diagram of propagation of multiple light beams in the camera optical lens shown in FIG. 16;

FIG. 18 is a schematic diagram of longitudinal aberration of the camera optical lens shown in FIG. 16;

FIG. 19 is a schematic diagram of lateral color of the camera optical lens shown in FIG. 16;

FIG. 20 is a schematic diagram of field curvature and distortion of the camera optical lens shown in FIG. 16;

FIG. 21 is a schematic structural diagram of a camera optical lens according to a comparative embodiment of the present disclosure;

FIG. 22 is a schematic diagram of propagation of multiple light beams in the camera optical lens shown in FIG. 21;

FIG. 23 is a schematic diagram of longitudinal aberration of the camera optical lens shown in FIG. 21;

FIG. 24 is a schematic diagram of lateral color of the camera optical lens shown in FIG. 21; and

FIG. 25 is a schematic diagram of field curvature and distortion of the camera optical lens shown in FIG. 21.

### DESCRIPTION OF EMBODIMENTS

In order to more clearly illustrate objectives, technical solutions, and advantages of embodiments of the present disclosure, the technical solutions in the embodiments of the present disclosure are clearly and completely described in details with reference to the drawings. However, those of ordinary skill in the art will appreciate that in various embodiments of the present disclosure, numerous technical details are set forth for the reader to better understand the present disclosure. However, even without these technical details and various variations and modifications based on the following embodiments, the technical solutions claimed in the present disclosure can still be implemented.

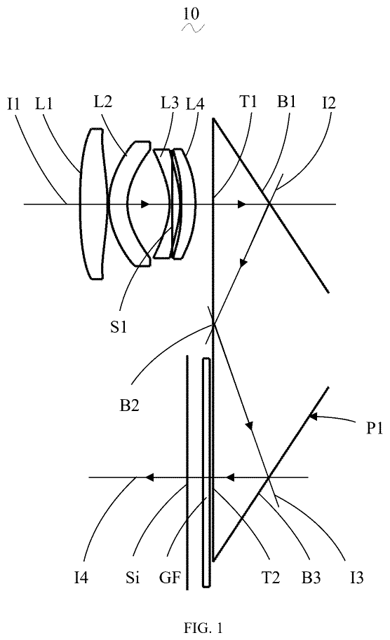

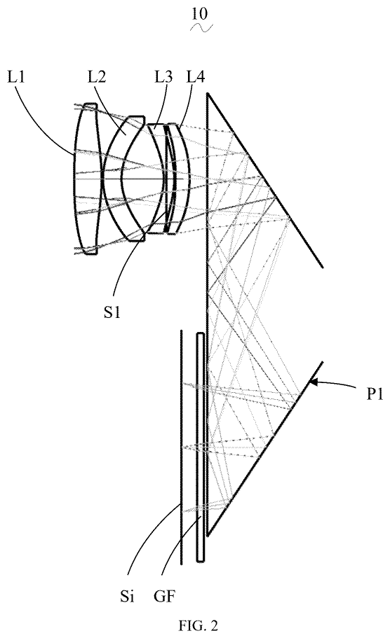

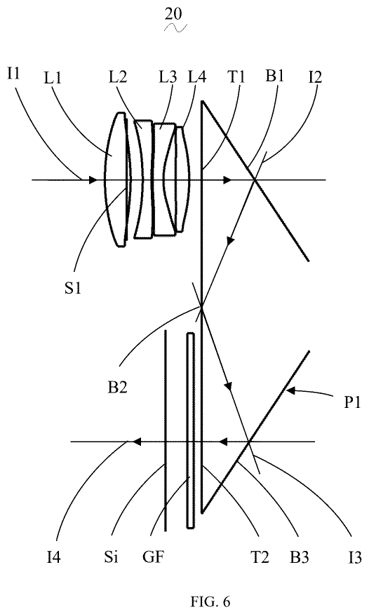

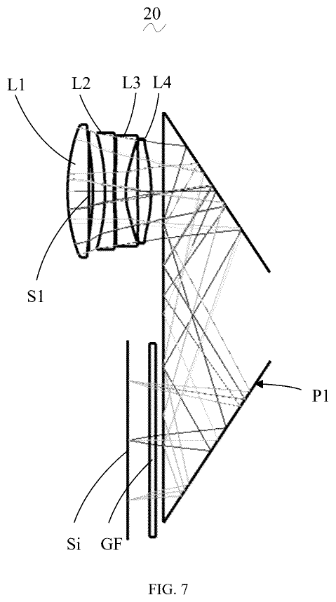

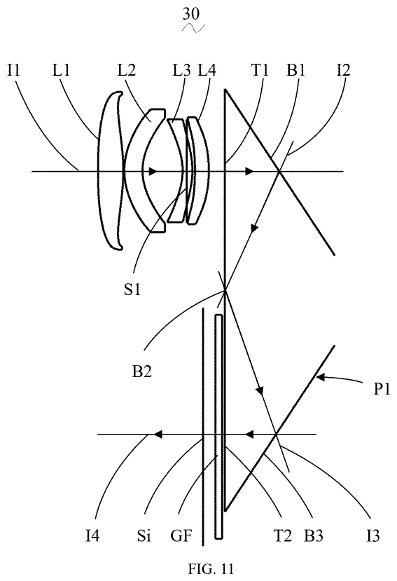

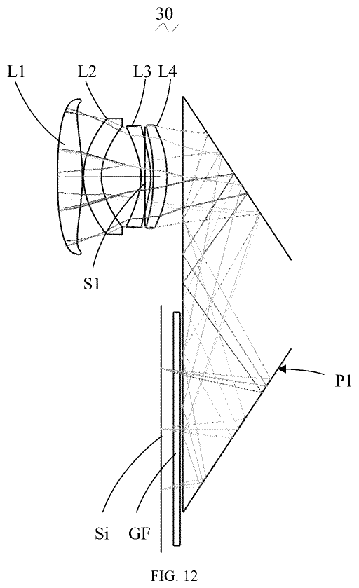

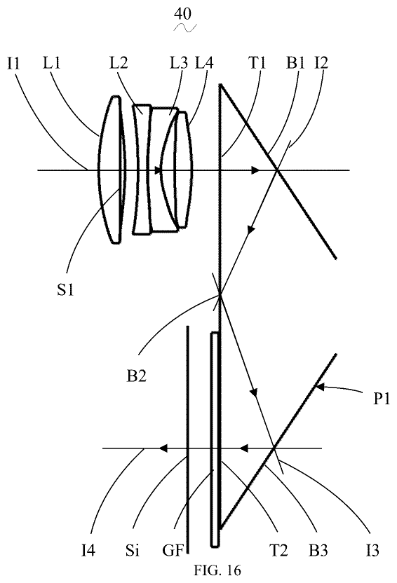

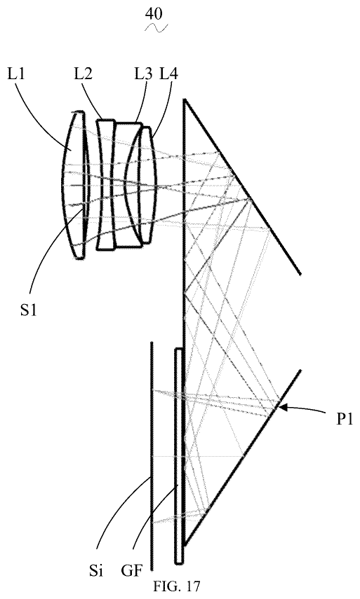

Referring to FIG. 1, FIG. 6, FIG. 11 and FIG. 16, technical solutions of the present disclosure provide a camera optical lens 10, 20, 30 and 40. The camera optical lens 10, 20, 30 and 40 includes from an object side to an image side: a first lens having a positive refractive power, a second lens having a negative refractive power, a third lens having a negative refractive power, a fourth lens having a positive refractive power, and a prism having a reflective power.

A focal length of the camera optical lens 10, 20, 30 and 40 is defined as f, a focal length of the first lens L1 is defined as f1, and the following relational expression is satisfied: 0.30f1/f≤0.70 is satisfied, which specifies the ratio of the focal length of the first lens L1 to the focal length of the camera optical lens 10, 20, 30 and 40. The camera optical lens 10, 20, 30 and 40 has better imaging quality and lower sensitivity by reasonably configuring the optical focal length of the system.

A combined focal length of the first lens L1 and the second lens L2 is defined as f12, and a combined focal length of the second lens L2, the third lens L3 and the fourth lens L4 is defined as f234, and the following relational expression is satisfied: −1.40≤f12/f234≤−0.426, which specifies the ratio of the combined focal length f12 of the first lens L1 and the second lens L2 to the combined focal length f234 of the second lens L2, the third lens L3, and the fourth lens L4. The system has better imaging quality and lower sensitivity by reasonably configuring the optical focal length of the system.

A central curvature radius of the object side surface of the first lens L1 is defined as R1, and a central curvature radius of the image side surface of the first lens L1 is defined as R2, and the following relational expression is satisfied: −3.00≤R1/R2−1.00, which specifies the ratio of the central curvature radius of the object side surface of the first lens L1 to the central curvature radius of the image side surface of the first lens L1, and defines the shape of the first lens L1, so as to help to correct astigmatism and distortion of the camera lens, to make the distortion |Distortion|≤0.8%, and to reduce the likelihood of vignetting.

An on-axis distance from the object side surface of the first lens L1 to the image side surface of the fourth lens L4 is defined as Td, and a total track length of the camera optical lens 10, 20, 30 and 40 is defined as TTL, and the following relational expression is satisfied: 0.16≤Td/TTL≤0.21, which specifies the ratio of the on-axis distance from the object side surface of the first lens L1 to the image side surface of the fourth lens L4 to the total track length of the camera optical lens 10. Within the range specified by the relational expression, a front end length of the periscope lens may be controlled to be shorter, so as to help to reduce the thickness of the lens assembly.

An on-axis thickness of the third lens L3 is defined as d5, and a distance in a direction parallel to the optical axis from a maximum effective aperture of an object side surface of the third lens L3 to a maximum effective aperture of an image side surface of the third lens L3 is defined as ET3, and the following relational expression is satisfied: 0.05≤d5/ET3≤0.66, which specifies the ratio of the on-axis thickness of the third lens L3 to the distance in the direction parallel to the optical axis from the maximum effective aperture of the object side surface of the third lens L3 to the maximum effective aperture of the image side surface of the third lens L3, so as to facilitate the processing of the third lens L3 and the assembly of the camera lens.

When the above relational expression are satisfied, the camera optical lens 10, 20, 30 and 40 has good optical performance and can satisfy the design requirements of long focus and miniaturization. According to the characteristics of the camera optical lens 10, 20, 30 and 40, the camera optical lens 10, 20, 30 and 40 are particularly suitable for the mobile phone camera optical lens assembly and the WEB camera optical lens composed of camera elements such as CCD and CMOS with high resolution.

Based on the above relational expressions and the achievable functions, the characteristics of each lens are further defined as follows.

An on-axis thickness of the third lens L3 is defined as d5, and an on-axis thickness of the fourth lens L4 is defined as d7, and the following relational expression is satisfied: 0.70≤d5/d7≤0.80, which specifies the ratio of the on-axis thickness of the third lens L3 to the on-axis thickness of the fourth lens L4. The molding difficulty of lens during the production process is reduced and a yield of the lens is improved by reasonably configuring thicknesses of the third lens L3 and the fourth lens L4.

The focal length of the first lens L1 is defined as f1, a central curvature radius of the object side surface of the first lens L1 is defined as R1, and a central curvature radius of the image side surface of the first lens L1 is defined as R2, and the following relational expression is satisfied: 2.7≤(R1−R2)/f1≤3.2, which specifies the ratio of the central curvature radius of the object side surface of the first lens L1 to the central curvature radius of the image side surface of the first lens L1, and defines the surface shape of the first lens L1, so as to effectively reduce the sensitivity of the system, to reduce the generation of stray light, thereby improving the overall imaging quality of the camera lens, and improving the manufacturing yield.

The object side surface of the first lens L1 is convex in a paraxial region, and the image side surface of the first lens L1 is convex in the paraxial region. The object side surface and the image side surface of the first lens L1 may also be configured with other concave and convex arrangements.

An on-axis thickness of the first lens L1 is defined as d1, and the total track length of the camera optical lens 10, 20, 30 and 40 is TTL, and the following relational expression is satisfied: 0.046≤d1/TTL≤0.051. Within the range of the relational expression, it is beneficial to achieve miniaturization.

An object side surface of the second lens L2 is convex or concave in a paraxial region, and an image side surface of the second lens L2 is concave in the paraxial region. The image side surface of the second lens L2 may also be convex.

The focal length of the camera optical lens 10, 20, 30 and 40 is defined as f, and a focal length of the second lens L2 is defined as f2, and the following relational expression is satisfied: −1.94≤f2/f≤−0.58, which specifies the ratio of the focal length f2 of the second lens L2 to the focal length f of the system. The system has better imaging quality and lower sensitivity through the reasonable configuration of refractive power.

A central curvature radius of the object side surface of the second lens L2 is R3, and a central curvature radius of the image side surface of the second lens L2 is R4, and the following relational expression is satisfied: −0.68≤(R3+R4)/(R3−R4)≤8.29, which specifies the ratio of the sum of the central curvature radius R3 of the object side surface of the second lens L2 and the central curvature radius R4 of the image side surface of the second lens L2 to the difference of the central curvature radius R3 of the object side surface of the second lens L2 and the central curvature radius R4 of the image side surface of the second lens L2, and defines the shape of the second lens L2. Within the range specified by the relational expression, it is conducive to correcting the on-axis chromatic aberrations, thereby improving the image clarity.

An on-axis thickness of the second lens L2 is d3, and the total track length of the camera optical lens 10, 20, 30 and 40 is TTL, and the following relational expression is satisfied: 0.016≤d3/TTL≤0.034. Within the range of relational expression, it is beneficial to achieve miniaturization.

The object side surface of the third lens L3 is convex or concave in a paraxial region, and the image side surface of the third lens L3 is concave or convex in the paraxial region.

The focal length of the camera optical lens 10, 20, 30 and 40 is defined as f, and a focal length of the third lens L3 is defined as f3, and the following relational expression is satisfied: −0.90≤f3/f≤−0.41, which specifies the ratio of the focal length f3 of the third lens L3 to the focal length f of the system. The system has better imaging quality and lower sensitivity through the reasonable configuration of refractive power.

A central curvature radius of the object side surface of the third lens L3 is R5, and a central curvature radius of the image side surface of the third lens L3 is R6, and the following relational expression is satisfied: −5.51≤(R5+R6)/(R5−R6)≤1.34, which specifies the ratio of the sum of the central curvature radius R5 of the object side surface of the third lens L3 and the central curvature radius R6 of the image side surface of the third lens L3 to the difference between the central curvature radius R5 of the object side surface of the third lens L3 and the central curvature radius R6 of the image side surface of the third lens L3, and defines the shape of the third lens L3. Within the range specified by the relational expression, it is conducive to the molding of the third lens L3, thereby reducing the degree of deflection of light passing through the lens and effectively reducing the aberration.

An on-axis thickness of the third lens L3 is d5, and the total track length of the camera optical lens 10, 20, 30 and 40 is TTL, the following relational expression is satisfied: 0.018≤d5/TTL≤0.024. Within the range of relational expression, it is beneficial to achieve miniaturization.

An object side surface of the fourth lens L4 is convex or concave in a paraxial region, and an image side surface of the fourth lens L4 is convex in the paraxial region. The image side surface of the fourth lens L4 may also be concave.

The focal length of the camera optical lens 10, 20, 30 and 40 are defined as f, and a focal length of the fourth lens L4 is defined as f4, and the following relational expression is satisfied: 0.72≤f4/f≤1.02, which specifies the ratio of the focal length f4 of the fourth lens L4 to the focal length f of the system. The system has better imaging quality and lower sensitivity through the reasonable configuration of refractive power.

A central curvature radius of the object side surface of the fourth lens L4 is R7, and a central curvature radius of the image side surface of the fourth lens L4 is R8, and the following relational expression is satisfied: 0.97≤(R7+R8)/(R7−R8)≤2.39, which specifies the ratio of the sum of the central curvature radius R7 of the object side surface of the fourth lens L4 and the central curvature radius R8 of the image side surface of the fourth lens L4 to the difference of the central curvature radius R7 of the object side surface of the fourth lens L4 and the central curvature radius R8 of the image side surface of the fourth lens L4, and defines the shape of the fourth lens L4. Within the range specified by the relational expression, it is conducive to correcting the on-axis chromatic aberrations

An on-axis thickness of the fourth lens L4 is d7, and the total track length of the camera optical lens 10, 20, 30 and 40 is TTL, the following relational expression is satisfied: 0.024≤d7/TTL≤0.030. Within the range of relational expression, it is beneficial to achieve miniaturization.

In the present disclosure, the first lens L1 is made of glass or plastic, the second lens L2, the third lens L3 and the fourth lens L4 are made of plastic, and the prism P1 is made of glass. The lenses and the prism P1 may also be made of other materials.

In the present disclosure, optical elements such as a grating filter GF are provided between the prism P1 and the image plane S1. The grating filter GF may be a glass cover plate or an optical filter. The grating filter GF may also be arranged at other positions.

In the present disclosure, an aperture S1 is further provided. The aperture S1 is arranged between the third lens L3 and the fourth lens L4, or arranged between the first lens L1 and the second lens L2. The aperture S1 may also be arranged at other positions.

The prism P1 has a reflective power. Along the optical axis, the prism P1 sequentially includes: a first transmissive surface T1, a first reflective surface B1, a second reflective surface B2, a third reflective surface B3 and a second transmissive surface T2. The first transmissive surface T1, the first reflective surface B1 and the second transmissive surface T2 are parallel to each other. The optical axe includes a first optical axis I1, a second optical axis I2, a third optical axis I3, and a fourth optical axis I4. The optical axis I1 intersects with the optical axis I2 at the first reflective surface B1, the second optical axis I2 intersects with the third optical axis I3 at the second reflective surface B2, and the third optical axis I3 intersects with the fourth optical axis I4 at the third reflective surface B3. The first optical axis I1 is parallel to the fourth optical axis I4, and the first optical axis I1 and the fourth optical axis I4 are in opposite directions. When the chief ray (main light)_with 0 field of view enters the camera optical lens 10 along the first optical axis I1, the light sequentially passes through the first lens L1, the second lens L2, the third lens L3 and the fourth lens L4, and then the light enters the prism P1 from the first transmissive surface T1. After being reflected by the first reflective surface B1, the light travels along the second optical axis I2. After being reflected by the second reflective surface B2, the light travels along the third optical axis I3. After being reflected by the third reflective surface B3, the light travels along the fourth optical axis I4. During the process of traveling along the fourth optical axis I4, the light exits from the second transmissive surface T2 and passes through the optical filter GF to reach the image plane S1.

The image height of the camera optical lens 10 is IH, and the total track length of the camera optical lens 10 is TTL, and the following relational expression is satisfied: TTL/IH≤5.26, which is conducive to miniaturization.

An f-number FNO of the camera optical lens 10 is less than or equal to 2.90, thereby achieving large aperture and the good imaging performance of the camera optical lens.

The focal length of the camera optical lens is f, and the total track length of the camera optical lens is TTL, and the following relational expression is satisfied: f/TTL<1.12, which is conducive to the miniaturization of the long-focus system. Optionally, f/TTL<0.75.

The camera optical lens of the present disclosure will be described below with examples. The reference signs recited in each example are shown below. The units of the focal length, the on-axis distance, the central curvature radius, and the on-axis thickness are mm.

TTL: a total track length (an on-axis distance from the object side surface of the first lens L1 to the image plane S1), in mm.

F-number FNO: refers to a ratio of the effective focal length of the camera optical lens to the entrance pupil diameter.

Image height IH at 1.0 field of view: a height of the field of view corresponding to the active pixel of the sensor (that is, half of the diagonal length of the active pixel area of the sensor).

Field of view FOV at 1.0 field of view: a field of view corresponding to the active pixel of the sensor.

Image height IHm at MIC field of view: a height of the field of view expanding beyond 1.0 field of view for preventing assembly deviation.

Field of view FOVm at MIC field of view: a field of view corresponding to an image height at MIC field of view.

Next, the technical solution of the present disclosure will be specifically described with four embodiments. Meanwhile, a comparative embodiment is provided as a reference description, showing that the technical effects of the present disclosure cannot be achieved when the ranges of the above relational expressions are exceeded.

### First Embodiment

The first lens L1 has a positive refractive power and is made of plastic. An object side surface of the first lens L1 is convex in a paraxial region, and an image side surface of the first lens L1 is convex in the paraxial region.

The second lens L2 has a negative refractive power and is made of plastic. An object side surface of the second lens L2 is convex in the paraxial region, and an image side surface of the second lens L2 is concave in the paraxial region.

The third lens L3 has a negative refractive power and is made of plastic. An object side surface of the third lens L3 is concave in a paraxial region, and an image side surface of the third lens L3 is convex in the paraxial region.

The fourth lens L4 has a positive refractive power and is made of plastic. An object side surface of the fourth lens L4 is concave in a paraxial region, and an image side surface of the fourth lens L4 is convex in the paraxial region.

An aperture S1 is provided between the third lens L3 and the fourth lens L4.

Table 1 and Table 2 show design data of the camera optical lens 10 according to the first embodiment of the present disclosure.

TABLE 1

| | R | d | | nd | | vd | |
|---|---|---|---|---|---|---|---|
| S1 | ∞ | d0= | −2.800 | | | | |
| R1 | 16.774 | d1= | 0.835 | nd1 | 1.5444 | vd1 | 55.82 |
| R2 | −6.174 | d2= | 0.040 | | | | |
| R3 | 2.107 | d3= | 0.562 | nd2 | 1.6610 | vd2 | 20.53 |
| R4 | 1.653 | d4= | 1.282 | | | | |
| R5 | −1.895 | d5= | 0.317 | nd3 | 1.6610 | vd3 | 20.53 |
| R6 | −2.737 | d6= | 0.040 | | | | |
| R7 | −10.002 | d7= | 0.424 | nd4 | 1.5444 | vd4 | 55.82 |
| R8 | −4.096 | d8= | 0.540 | | | | |
| R9 | ∞ | d9= | 1.754 | nd5 | 1.5688 | vd5 | 56.06 |
| R10 | ∞ | d10= | 4.446 | | | | |
| R11 | ∞ | d11= | 4.446 | | | | |
| R12 | ∞ | d12= | 1.754 | | | | |
| R13 | ∞ | d13= | 0.100 | | | | |
| R14 | ∞ | d14= | 0.210 | ndg | 1.5168 | vdg | 64.17 |
| R15 | ∞ | d15= | 0.472 | | | | |

The meaning of each reference sign is as follows:
S1: aperture;
R: central curvature radius at the center of the optical surface;
R1: central curvature radius of the object side surface of the first lens L1;
R2: central curvature radius of the image side surface of the first lens L1;
R3: central curvature radius of the object side surface of the second lens L2;
R4: central curvature radius of the image side surface of the second lens L2;
R5: central curvature radius of the object side surface of the third lens L3;
R6: central curvature radius of the image side surface of the third lens L3;
R7: central curvature radius of the object side surface of the fourth lens L4;
R8: central curvature radius of the image side surface of the fourth lens L4;
R9: central curvature radius of the first transmissive surface of the prism P1;
R10: central curvature radius of the first reflective surface of the prism P1;
R11: central curvature radius of the second reflective surface of the prism P1;
R12: center curvature radius of the third reflective surface of the prism P1;
R13: central curvature radius of the second transmissive surface of the prism P1;
R14: central curvature radius of the object side surface of the grating filter GF;
R15: central curvature radius of the image side surface of the grating filter GF;
d: on-axis thickness of the lens or on-axis distance between the lenses;
d0: on-axis distance from the aperture S1 to the object side surface of the first lens L1;
d1: on-axis thickness of the first lens L1;
d2: on-axis distance from the image side surface of the first lens L1 to the object side surface of the second lens L2;
d3: on-axis thickness of the second lens L2;
d4: on-axis distance from the image side surface of the second lens L2 to the object side surface of the third lens L3;
d5: on-axis thickness of the third lens L3;
d6: on-axis distance from the image side surface of the third lens L3 to the object side surface of the fourth lens L4;
d7: on-axis thickness of the fourth lens L4;
d8: on-axis distance from the image side surface of the fourth lens L4 to the first transmissive surface of the prism P1;
d9: on-axis distance of the chief ray at the 0 field of view from the first transmissive surface of the prism P1 to the first reflective surface of the prism P1;
d10: on-axis distance of the chief ray at the 0 field of view from the first reflective surface of the prism P1 to the second reflective surface of the prism P1;
d11: on-axis distance of the chief ray at the 0 field of view from the second reflective surface of the prism P1 to the third reflective surface of the prism P1;
d12: on-axis distance of the chief ray at the 0 field of view from the third reflective surface of the prism P1 to the third transmissive surface of the prism P1;
d13: on-axis distance from the second transmissive surface of the prism P1 to the object side surface of the grating filter GF;
d14: on-axis thickness of the grating filter GF;
d15: on-axis distance from the image side surface of the grating filter GF to the image plane S1;
nd: refractive index of d line (the d line is green light with a wavelength of 550 nm);
nd1: refractive index of d line of the first lens L1;
nd2: refractive index of d line of the second lens L2;
nd3: refractive index of d line of the third lens L3;
nd4: refractive index of d line of the fourth lens L4;
nd5: refractive index of d line of the prism P1;
ndg: refractive index of d line of the grating filter GF;
vd: Abbe number;
vd1: Abbe number of the first lens L1;
vd2: Abbe number of the second lens L2;
vd3: Abbe number of the third lens L3;
vd4: Abbe number of the fourth lens L4;
vd5: Abbe number of the prism P1;
vdg: Abbe number of the grating filter GF.

Table 2 shows aspheric data of each lens in the camera optical lens 10 according to the first embodiment of the present disclosure.

TABLE 2

| | Conic | | | | | |
|---|---|---|---|---|---|---|
| | Coefficient | Aspheric Coefficient | | | | |
| | k | A4 | A6 | A8 | A10 | A12 |
| R1 | −3.2590E+00 | 1.1352E−02 | −1.9780E−02 | 5.2458E−02 | −8.3439E−02 | 8.3681E−02 |
| R2 | 1.7009E−01 | −3.5713E−02 | 1.8136E−01 | −3.2249E−01 | 3.4640E−01 | −2.4665E−01 |
| R3 | −2.4979E+00 | −3.9729E−02 | 1.3358E−01 | −1.5640E−01 | 2.8700E−02 | 1.4220E−01 |
| R4 | −2.0279E+00 | −5.7021E−03 | −7.8822E−02 | 4.7081E−01 | −1.2642E+00 | 2.0293E+00 |
| R5 | −3.2985E+00 | −6.4363E−03 | 1.1421E−01 | −2.8564E−01 | 4.3503E−01 | −4.3907E−01 |
| R6 | 2.6018E−01 | −4.2095E−02 | 3.6899E−01 | −8.9257E−01 | 1.4207E+00 | −1.5412E+00 |
| R7 | 1.0000E+01 | −1.1919E−01 | 4.0287E−01 | −1.0856E+00 | 2.0762E+00 | −2.8232E+00 |
| R8 | −6.4291E+00 | −2.3792E−02 | −2.6475E−03 | −7.5229E−05 | 1.7874E−02 | −3.0319E−02 |
| | Conic | | | | | |
| | Coefficient | Aspheric Coefficient | | | | |
| | k | A14 | A16 | A18 | A20 | A22 |
| R1 | −3.2590E+00 | −5.6006E−02 | 2.5868E−02 | −8.3676E−03 | 1.8920E−03 | −2.9297E−04 |
| R2 | 1.7009E−01 | 1.2129E−01 | −4.1883E−02 | 1.0143E−02 | −1.6871E−03 | 1.8355E−04 |
| R3 | −2.4979E+00 | −1.9766E−01 | 1.3727E−01 | −5.9017E−02 | 1.6363E−02 | −2.8600E−03 |
| R4 | −2.0279E+00 | −2.1232E+00 | 1.5024E+00 | −7.2607E−01 | 2.3640E−01 | −4.9607E−02 |
| R5 | −3.2985E+00 | 2.9347E−01 | −1.2765E−01 | 3.4635E−02 | −5.3172E−03 | 3.5279E−04 |
| R6 | 2.6018E−01 | 1.1366E+00 | −5.6612E−01 | 1.8742E−01 | −3.9603E−02 | 4.8510E−03 |
| R7 | 1.0000E+01 | 2.7622E+00 | −1.9793E+00 | 1.0502E+00 | −4.1031E−01 | 1.1484E−01 |
| R8 | −6.4291E+00 | 2.3351E−02 | −9.4358E−03 | 1.9493E−03 | −1.6284E−04 | 0.0000E+00 |

| | Conic | | | | | |
|---|---|---|---|---|---|---|
| | Coefficient | Aspheric Coefficient | | | | |
| | k | A24 | A26 | A28 | A30 | / |
| R1 | −3.2590E+00 | 2.9598E−05 | −1.7572E−06 | 4.6486E−08 | 0.0000E+00 | / |
| R2 | 1.7009E−01 | −1.1759E−05 | 3.3619E−07 | 0.0000E+00 | 0.0000E+00 | / |
| R3 | −2.4979E+00 | 2.8754E−04 | −1.2701E−05 | 0.0000E+00 | 0.0000E+00 | / |
| R4 | −2.0279E+00 | 6.0579E−03 | −3.2692E−04 | 0.0000E+00 | 0.0000E+00 | / |
| R5 | −3.2985E+00 | 0.0000E+00 | 0.0000E+00 | 0.0000E+00 | 0.0000E+00 | / |
| R6 | 2.6018E−01 | −2.6319E−04 | 0.0000E+00 | 0.0000E+00 | 0.0000E+00 | / |
| R7 | 1.0000E+01 | −2.1743E−02 | 2.4871E−03 | −1.2948E−04 | 0.0000E+00 | / |
| R8 | −6.4291E+00 | 0.0000E+00 | 0.0000E+00 | 0.0000E+00 | 0.0000E+00 | / |

For convenience, the aspheric of each lens surface uses the aspheric shown in the following formula (1). However, the present disclosure is not limited to the aspheric polynomial form represented by formula (1).

$$z = ( c {r}^{2} ) / \{ 1 + {[ 1 - ( k + 1 ) ( {c}^{2} {r}^{2} ) ]}^{1 / 2} \} + A 4 {r}^{4} + A 6 {r}^{6} + {A8r}^{8} + A 10 {r}^{10} + A 12 {r}^{12} + A 14 {r}^{14} + A 16 {r}^{16} + A 18 {r}^{18} + A 20 {r}^{20} + A 22 {r}^{22} + A 24 {r}^{24} + A 26 {r}^{26} + A 28 {r}^{28} + A 30 {r}^{30} , \qquad ( 1 )$$

where k represents a conic coefficient, A4, A6, A8, A10, A12, A14, A16, A18, A20, A22, A24, A26, A28 and A30 represent aspheric coefficients, c represents a curvature at the center of the optical surface, r represents a vertical distance between a point on the aspheric curve and the optical axis, and z represents a depth of the aspheric (a vertical distance between a point on the aspheric at a distance r from the optical axis and a tangent plane tangent to a vertex on the aspheric optical axis).

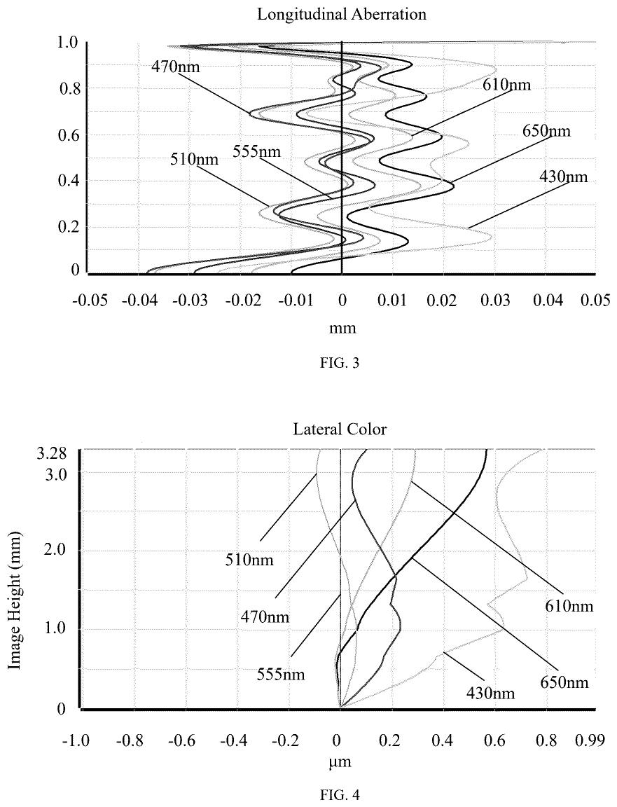

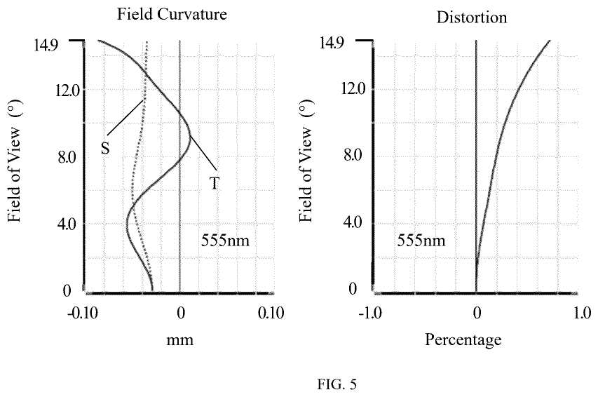

FIG. 3 and FIG. 4 respectively show longitudinal aberration and lateral color of the light at wavelengths of 650 nm, 610 nm, 555 nm, 510 nm, 470 nm and 430 nm after passing through the camera optical lens 10 according to the first embodiment. FIG. 5 shows field curvature and distortion of the light at a wavelength of 555 nm after passing through the camera optical lens 10 according to the first embodiment. In FIG. 5, the field curvature S is a field curvature in a sagittal direction, and Tis a field curvature in a meridian direction.

In this embodiment, the entrance pupil diameter ENPD of the camera optical lens 10 is 4.217 mm, the image height IH at the 1.0 field of view is 3.277 mm, the field of view FOV at the 1.0 field of view is 29.81°, the image height IHm at the MIC field of view is 3.575 mm, and the field of view FOVm at the MIC field of view is 32.35°. The camera optical lens 10 meets the design requirements of long focus and miniaturization, effectively correcting both the on-axis and off-axis chromatic aberrations thereof, and has excellent optical characteristics.

### Second Embodiment

The meaning of the reference signs of the second embodiment is the same as that of the first embodiment.

Different from the first embodiment, in this embodiment, the object side surface of the second lens L2 is concave in the paraxial region. The object side surface of the third lens L3 is convex in the paraxial region, and the image side surface of the third lens L3 is concave in the paraxial region. The object side surface of the fourth lens L4 is convex in the paraxial region. The first lens L1 is made of glass. The aperture S1 is arranged between the first lens L1 and the second lens L2.

FIG. 6 shows a camera optical lens 20 according to the second embodiment of the present disclosure.

Table 3 and Table 4 show design data of the camera optical lens 20 according to the second embodiment of the present disclosure.

TABLE 3

| | R | d | | nd | | vd | |
|---|---|---|---|---|---|---|---|
| S1 | ∞ | d0= | −0.250 | | | | |
| R1 | 6.714 | d1= | 0.836 | nd1 | 1.8063 | vd1 | 40.92 |
| R2 | −5.296 | d2= | 0.391 | | | | |
| R3 | −4.614 | d3= | 0.289 | nd2 | 1.5444 | vd2 | 55.82 |
| R4 | 24.037 | d4= | 0.036 | | | | |
| R5 | 29.365 | d5= | 0.349 | nd3 | 1.6359 | vd3 | 23.83 |
| R6 | 2.897 | d6= | 0.389 | | | | |
| R7 | 840.062 | d7= | 0.445 | nd4 | 1.5444 | vd4 | 55.82 |
| R8 | −4.767 | d8= | 0.250 | | | | |
| R9 | ∞ | d9= | 1.904 | nd5 | 1.5688 | vd5 | 56.06 |
| R10 | ∞ | d10= | 4.446 | | | | |
| R11 | ∞ | d11= | 4.446 | | | | |
| R12 | ∞ | d12= | 1.904 | | | | |
| R13 | ∞ | d13= | 0.100 | | | | |
| R14 | ∞ | d14= | 0.210 | ndg | 1.5168 | vdg | 64.17 |
| R15 | ∞ | d15= | 0.710 | | | | |

Table 4 shows aspheric data of each lens in the camera optical lens 20 according to the second embodiment of the present disclosure.

TABLE 4

| | |
|---|---|
| Conic Coefficient | Aspheric Coefficient |

| | k | A4 | A6 | A8 | A10 | A12 |
|---|---|---|---|---|---|---|
| R1 | −1.3393E+00 | 5.5852E−03 | 1.7046E−03 | −4.8464E−03 | 2.7804E−03 | −6.4530E−04 |
| R2 | −3.2125E+00 | 5.1369E−02 | −3.7746E−02 | 1.0055E−02 | 4.1656E−03 | −4.1123E−03 |
| R3 | −2.3640E+01 | 1.3596E−01 | −2.8675E−01 | 2.7312E−01 | −1.4775E−01 | 4.8130E−02 |
| R4 | −1.4076E+01 | 5.9841E−02 | −1.7865E−02 | −1.3108E−01 | 1.8390E−01 | −1.1749E−01 |
| R5 | −9.6401E+01 | 4.0627E−02 | 9.5788E−02 | −3.1681E−01 | 3.3099E−01 | −1.8297E−01 |
| R6 | −7.6709E+00 | 1.4254E−01 | −1.7053E−01 | 9.8493E−04 | 1.4277E−01 | −1.4436E−01 |
| R7 | 9.9000E+01 | 8.0530E−02 | −9.7172E−02 | 4.6147E−02 | −4.9229E−02 | 7.2312E−02 |
| R8 | −2.3501E+00 | 2.7179E−02 | −2.5108E−02 | −6.7386E−04 | 1.3543E−02 | −1.2216E−02 |

| | Conic Coefficient | Aspheric Coefficient | | | | |
|---|---|---|---|---|---|---|
| | k | A14 | A16 | A18 | A20 | A22 |
| R1 | −1.3393E+00 | 2.0636E−05 | 1.8939E−05 | −3.4542E−06 | 1.9458E−07 | 0.0000E+00 |
| R2 | −3.2125E+00 | 1.4149E−03 | −2.5811E−04 | 2.5060E−05 | −1.0257E−06 | 0.0000E+00 |
| R3 | −2.3640E+01 | −9.4207E−03 | 1.0376E−03 | −5.2500E−05 | 4.5257E−07 | 0.0000E+00 |
| R4 | −1.4076E+01 | 4.2523E−02 | −8.9292E−03 | 1.0067E−03 | −4.6527E−05 | 0.0000E+00 |
| R5 | −9.6401E+01 | 5.9694E−02 | −1.1514E−02 | 1.2024E−03 | −5.1252E−05 | 0.0000E+00 |
| R6 | −7.6709E+00 | 7.6939E−02 | −2.4469E−02 | 4.3590E−03 | −3.3391E−04 | 0.0000E+00 |
| R7 | 9.9000E+01 | −5.9928E−02 | 2.9781E−02 | −9.1622E−03 | 1.6212E−03 | −1.2585E−04 |
| R8 | −2.3501E+00 | 7.9053E−03 | −3.4433E−03 | 8.2197E−04 | −7.9393E−05 | 0.0000E+00 |

| | Conic Coefficient | Aspheric Coefficient | | | | |
|---|---|---|---|---|---|---|
| | k | A24 | A26 | A28 | A30 | / |
| R1 | −1.3393E+00 | 0.0000E+00 | 0.0000E+00 | 0.0000E+00 | 0.0000E+00 | / |
| R2 | −3.2125E+00 | 0.0000E+00 | 0.0000E+00 | 0.0000E+00 | 0.0000E+00 | / |
| R3 | −2.3640E+01 | 0.0000E+00 | 0.0000E+00 | 0.0000E+00 | 0.0000E+00 | / |
| R4 | −1.4076E+01 | 0.0000E+00 | 0.0000E+00 | 0.0000E+00 | 0.0000E+00 | / |
| R5 | −9.6401E+01 | 0.0000E+00 | 0.0000E+00 | 0.0000E+00 | 0.0000E+00 | / |
| R6 | −7.6709E+00 | 0.0000E+00 | 0.0000E+00 | 0.0000E+00 | 0.0000E+00 | / |
| R7 | 9.9000E+01 | 0.0000E+00 | 0.0000E+00 | 0.0000E+00 | 0.0000E+00 | / |
| R8 | −2.3501E+00 | 0.0000E+00 | 0.0000E+00 | 0.0000E+00 | 0.0000E+00 | / |

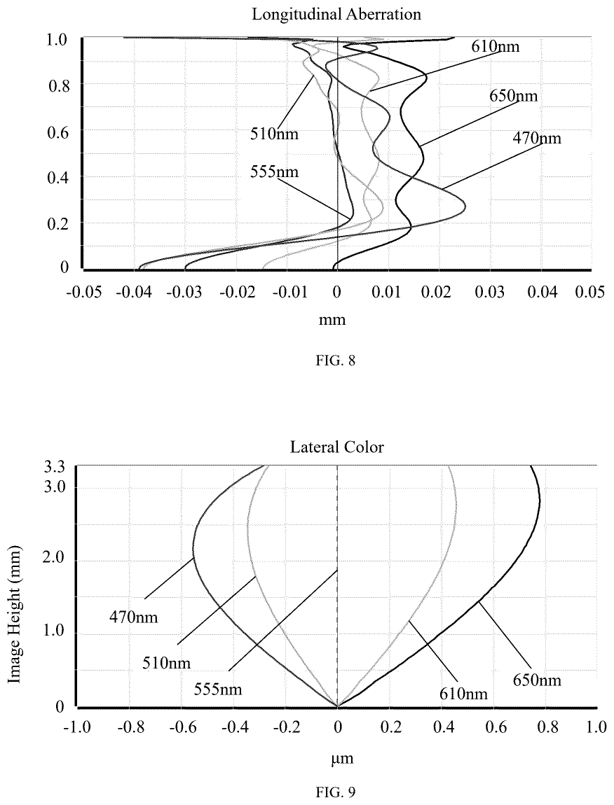

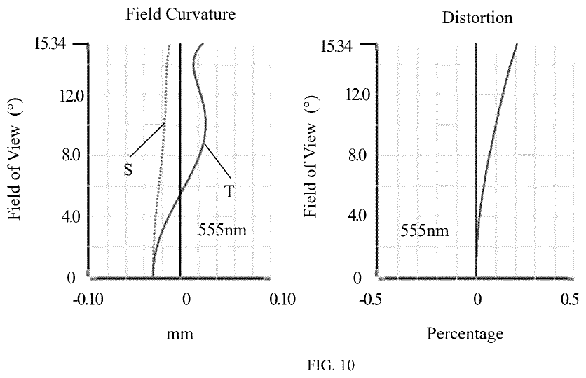

FIG. 8 and FIG. 9 respectively show longitudinal aberration and lateral color of the light at wavelengths of 650 nm, 610 nm, 555 nm, 510 nm and 470 nm after passing through the camera optical lens 20 according to the second embodiment. FIG. 10 shows field curvature and distortion of the light at a wavelength of 555 nm after passing through the camera optical lens 20 according to the second embodiment. In FIG. 10, the field curvature S is a field curvature in a sagittal direction, and T is a field curvature in a meridional direction.

In this embodiment, the entrance pupil diameter ENPD of the camera optical lens 20 is 4.142 mm, the image height IH at the 1.0 field of view is 3.277 mm, the field of view FOV at the 1.0 field of view is 30.48°, the image height IHm at the MIC field of view is 3.300 mm, and the field of view FOVm at the MIC field of view is 30.69°. The camera optical lens 20 meets the design requirements of long focus and miniaturization, effectively correcting both the on-axis and off-axis chromatic aberrations thereof, and has excellent optical characteristics.

### Third Embodiment

The meaning of the reference signs of the third embodiment is the same as that of the first embodiment.

FIG. 11 shows a camera optical lens 30 according to the third embodiment of the present disclosure.

Table 5 and Table 6 show design data of the camera optical lens 30 according to the third embodiment of the present disclosure.

TABLE 5

| | R | d | | nd | | vd | |
|---|---|---|---|---|---|---|---|
| S1 | ∞ | d0= | −2.815 | | | | |
| R1 | 18.104 | d1= | 0.805 | nd1 | 1.5444 | vd1 | 55.82 |
| R2 | −6.041 | d2= | 0.031 | | | | |
| R3 | 2.128 | d3= | 0.577 | nd2 | 1.6610 | vd2 | 20.53 |
| R4 | 1.668 | d4= | 1.275 | | | | |
| R5 | −1.904 | d5= | 0.309 | nd3 | 1.6610 | vd3 | 20.53 |
| R6 | −2.761 | d6= | 0.082 | | | | |
| R7 | −10.815 | d7= | 0.441 | nd4 | 1.5444 | vd4 | 55.82 |
| R8 | −4.174 | d8= | 0.524 | | | | |
| R9 | ∞ | d9= | 1.734 | nd5 | 1.5688 | vd5 | 56.06 |
| R10 | ∞ | d10= | 4.426 | | | | |
| R11 | ∞ | d11= | 4.426 | | | | |
| R12 | ∞ | d12= | 1.734 | | | | |
| R13 | ∞ | d13= | 0.100 | | | | |
| R14 | ∞ | d14= | 0.210 | ndg | 1.5168 | vdg | 64.17 |
| R15 | ∞ | d15= | 0.400 | | | | |

Table 6 shows aspheric data of each lens in the camera optical lens 30 according to the third embodiment of the present disclosure.

TABLE 6

| | Conic | | | | | |
|---|---|---|---|---|---|---|
| | Coefficient | Aspheric Coefficient | | | | |
| | k | A4 | A6 | A8 | A10 | A12 |
| R1 | −3.3165E+00 | 1.1353E−02 | −1.9780E−02 | 5.2459E−02 | −8.3439E−02 | 8.3681E−02 |
| R2 | 1.6855E−01 | −3.5729E−02 | 1.8137E−01 | −3.2249E−01 | 3.4640E−01 | −2.4665E−01 |
| R3 | −2.4963E+00 | −3.9739E−02 | 1.3358E−01 | −1.5640E−01 | 2.8700E−02 | 1.4220E−01 |
| R4 | −2.0273E+00 | −5.6736E−03 | −7.8808E−02 | 4.7081E−01 | −1.2642E+00 | 2.0293E+00 |
| R5 | −3.2988E+00 | −6.4284E−03 | 1.1422E−01 | −2.8564E−01 | 4.3503E−01 | −4.3907E−01 |
| R6 | 2.6074E−01 | −4.2071E−02 | 3.6900E−01 | −8.9255E−01 | 1.4207E+00 | −1.5412E+00 |
| R7 | 1.0109E+01 | −1.1944E−01 | 4.0324E−01 | −1.0855E+00 | 2.0762E+00 | −2.8232E+00 |
| R8 | −5.5480E+00 | −2.3330E−02 | −1.8805E−03 | −7.1689E−05 | 1.7848E−02 | −3.0327E−02 |
| | Conic | | | | | |
| | Coefficient | Aspheric Coefficient | | | | |
| | k | A14 | A16 | A18 | A20 | A22 |
| R1 | −3.3165E+00 | −5.6006E−02 | 2.5868E−02 | −8.3676E−03 | 1.8920E−03 | −2.9297E−04 |
| R2 | 1.6855E−01 | 1.2129E−01 | −4.1883E−02 | 1.0143E−02 | −1.6871E−03 | 1.8355E−04 |
| R3 | −2.4963E+00 | −1.9766E−01 | 1.3727E−01 | −5.9017E−02 | 1.6363E−02 | −2.8600E−03 |
| R4 | −2.0273E+00 | −2.1232E+00 | 1.5024E+00 | −7.2607E−01 | 2.3640E−01 | −4.9607E−02 |
| R5 | −3.2988E+00 | 2.9347E−01 | −1.2765E−01 | 3.4635E−02 | −5.3172E−03 | 3.5279E−04 |
| R6 | 2.6074E−01 | 1.1366E+00 | −5.6612E−01 | 1.8742E−01 | −3.9603E−02 | 4.8510E−03 |
| R7 | 1.0109E+01 | 2.7622E+00 | −1.9793E+00 | 1.0502E+00 | −4.1031E−01 | 1.1484E−01 |
| R8 | −5.5480E+00 | 2.3351E−02 | −9.4357E−03 | 1.9494E−03 | −1.6286E−04 | 0.0000E+00 |

| | Conic | | | | | |
|---|---|---|---|---|---|---|
| | Coefficient | Aspheric Coefficient | | | | |
| | k | A24 | A26 | A28 | A30 | / |
| R1 | −3.3165E+00 | 2.9598E−05 | −1.7572E−06 | 4.6486E−08 | 0.0000E+00 | / |
| R2 | 1.6855E−01 | −1.1759E−05 | 3.3619E−07 | −1.5237E−14 | 0.0000E+00 | / |
| R3 | −2.4963E+00 | 2.8754E−04 | −1.2701E−05 | 0.0000E+00 | 0.0000E+00 | / |
| R4 | −2.0273E+00 | 6.0579E−03 | −3.2692E−04 | 0.0000E+00 | 0.0000E+00 | / |
| R5 | −3.2988E+00 | −4.6660E−10 | 0.0000E+00 | 0.0000E+00 | 0.0000E+00 | / |
| R6 | 2.6074E−01 | −2.6319E−04 | 0.0000E+00 | 0.0000E+00 | 0.0000E+00 | / |
| R7 | 1.0109E+01 | −2.1743E−02 | 2.4871E−03 | −1.2948E−04 | 0.0000E+00 | / |
| R8 | −5.5480E+00 | 0.0000E+00 | 0.0000E+00 | 0.0000E+00 | 0.0000E+00 | / |

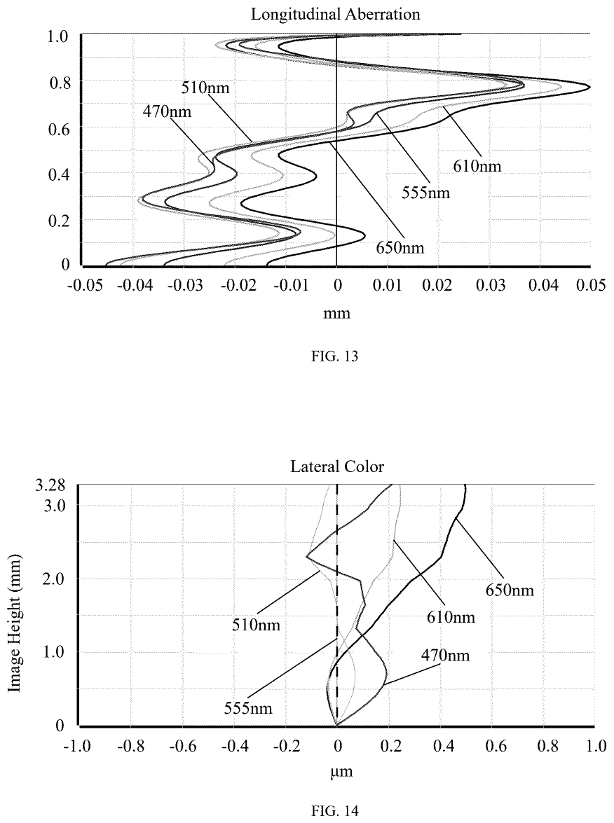

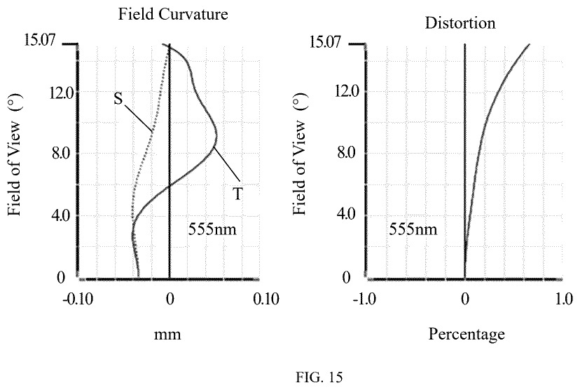

FIG. 13 and FIG. 14 respectively show longitudinal aberration and lateral color of the light at wavelengths of 650 nm, 610 nm, 555 nm, 510 nm and 470 nm after passing through the camera optical lens 30 according to the third embodiment. FIG. 15 shows field curvature and distortion of the light at a wavelength of 555 nm after passing through the camera optical lens 30 according to the third embodiment. In FIG. 15, the field curvature S is a field curvature in a sagittal direction, and T is a field curvature in a meridional direction.

In this embodiment, the entrance pupil diameter ENPD of the camera optical lens 30 is 4.167 mm, the image height IH at the 1.0 field of view is 3.277 mm, the field of view FOV at the 1.0 field of view is 30.15°, the image height IHm at the MIC field of view is 3.300 mm, and the field of view FOVm at the MIC field of view is 30.35°. The camera optical lens 30 meets the design requirements of long focus and miniaturization, effectively correcting both the on-axis and off-axis chromatic aberrations thereof, and has excellent optical characteristics.

### Fourth Embodiment

The meaning of the reference signs of the fourth embodiment is the same as that of the first embodiment.

Different from the first embodiment, in this embodiment, the object side surface of the second lens L2 is concave in the paraxial region. The object side surface of the third lens L3 is convex in the paraxial region, and the image side surface of the third lens L3 is concave in the paraxial region. The object side surface of the fourth lens L4 is convex in the paraxial region. The first lens L1 is made of glass. The aperture S1 is arranged between the first lens L1 and the second lens L2.

FIG. 16 shows a camera optical lens 40 according to the fourth embodiment of the present disclosure.

Table 7 and Table 8 show design data of the camera optical lens 40 according to the fourth embodiment of the present disclosure.

TABLE 7

| | R | d | | nd | | vd | |
|---|---|---|---|---|---|---|---|
| S1 | ∞ | d0= | −0.632 | | | | |
| R1 | 6.282 | d1= | 0.776 | nd1 | 1.8063 | vd1 | 40.92 |
| R2 | −6.232 | d2= | 0.381 | | | | |
| R3 | −7.653 | d3= | 0.275 | nd2 | 1.5444 | vd2 | 55.82 |
| R4 | 13.412 | d4= | 0.012 | | | | |
| R5 | 19.384 | d5= | 0.387 | nd3 | 1.6359 | vd3 | 23.83 |
| R6 | 2.787 | d6= | 0.407 | | | | |
| R7 | 557.987 | d7= | 0.498 | nd4 | 1.5444 | vd4 | 55.82 |
| R8 | −5.777 | d8= | 0.896 | | | | |
| R9 | ∞ | d9= | 1.654 | nd5 | 1.5688 | vd5 | 56.06 |
| R10 | ∞ | d10= | 4.346 | | | | |
| R11 | ∞ | d11= | 4.346 | | | | |
| R12 | ∞ | d12= | 1.654 | | | | |
| R13 | ∞ | d13= | 0.100 | | | | |
| R14 | ∞ | d14= | 0.210 | ndg | 1.5168 | vdg | 64.17 |
| R15 | ∞ | d15= | 0.704 | | | | |

Table 8 shows aspheric data of each lens in the camera optical lens 40 according to the fourth embodiment of the present disclosure.

TABLE 8

| | |
|---|---|
| Conic | |
| Coefficient | Aspheric Coefficient |

| | k | A4 | A6 | A8 | A10 | A12 |
|---|---|---|---|---|---|---|
| R1 | −2.1211E+00 | 5.2233E−03 | 1.5782E−03 | −4.8664E−03 | 2.7793E−03 | −6.4400E−04 |
| R2 | −9.6444E−01 | 5.0228E−02 | −3.7607E−02 | 1.0104E−02 | 4.1691E−03 | −4.1127E−03 |
| R3 | −5.5523E+01 | 1.3888E−01 | −2.8631E−01 | 2.7311E−01 | −1.4777E−01 | 4.8125E−02 |
| R4 | 1.9775E+01 | 6.0391E−02 | −1.7797E−02 | −1.3099E−01 | 1.8391E−01 | −1.1749E−01 |
| R5 | 3.2732E+01 | 4.1240E−02 | 9.6103E−02 | −3.1682E−01 | 3.3100E−01 | −1.8296E−01 |
| R6 | −6.4741E+00 | 1.4328E−01 | −1.6940E−01 | 1.5474E−03 | 1.4287E−01 | −1.4436E−01 |
| R7 | −1.5475E+06 | 8.6721E−02 | −9.6486E−02 | 4.6212E−02 | −4.9157E−02 | 7.2343E−02 |
| R8 | −4.3904E+00 | 2.8456E−02 | −2.4434E−02 | −4.9814E−04 | 1.3446E−02 | −1.2256E−02 |

| | Conic | | | | | |
|---|---|---|---|---|---|---|
| | Coefficient | Aspheric Coefficient | | | | |
| | k | A14 | A16 | A18 | A20 | A22 |
| R1 | −2.1211E+00 | 2.0912E−05 | 1.8973E−05 | −3.4578E−06 | 1.9232E−07 | −3.2132E−10 |
| R2 | −9.6444E−01 | 1.4147E−03 | −2.5811E−04 | 2.5064E−05 | −1.0264E−06 | −9.2504E−11 |
| R3 | −5.5523E+01 | −9.4219E−03 | 1.0373E−03 | −5.2505E−05 | 4.5718E−07 | 4.7396E−09 |
| R4 | 1.9775E+01 | 4.2522E−02 | −8.9292E−03 | 1.0068E−03 | −4.6501E−05 | 9.5117E−09 |
| R5 | 3.2732E+01 | 5.9696E−02 | −1.1513E−02 | 1.2025E−03 | −5.1223E−05 | 4.8874E−09 |
| R6 | −6.4741E+00 | 7.6933E−02 | −2.4471E−02 | 4.3591E−03 | −3.3391E−04 | 5.3476E−10 |
| R7 | −1.5475E+06 | −5.9923E−02 | 2.9779E−02 | −9.1638E−03 | 1.6205E−03 | −1.2602E−04 |
| R8 | −4.3904E+00 | 7.9017E−03 | −3.4413E−03 | 8.2284E−04 | −7.9260E−05 | −1.0779E−07 |

| | Conic | | | | | |
|---|---|---|---|---|---|---|
| | Coefficient | Aspheric Coefficient | | | | |
| | k | A24 | A26 | A28 | A30 | / |
| R1 | −2.1211E+00 | −4.5214E−11 | 3.8066E−12 | 2.1949E−12 | 4.6063E−14 | / |
| R2 | −9.6444E−01 | −1.0209E−10 | −1.8326E−11 | −1.4114E−12 | 1.7188E−12 | / |
| R3 | −5.5523E+01 | 1.3384E−09 | 1.5791E−10 | 2.2936E−11 | −2.9841E−11 | / |
| R4 | 1.9775E+01 | 3.0025E−09 | 3.1886E−10 | −1.7710E−10 | −1.8863E−10 | / |
| R5 | 3.2732E+01 | 1.0316E−09 | −5.0961E−10 | −3.8601E−10 | −1.5783E−10 | / |
| R6 | −6.4741E+00 | −2.0049E−09 | −4.1107E−09 | 3.9403E−10 | 1.8496E−09 | / |
| R7 | −1.5475E+06 | −3.2770E−08 | 6.3462E−09 | 6.4012E−09 | 2.8370E−09 | / |
| R8 | −4.3904E+00 | −7.0088E−08 | −2.4524E−08 | −2.0734E−09 | 4.6585E−09 | / |

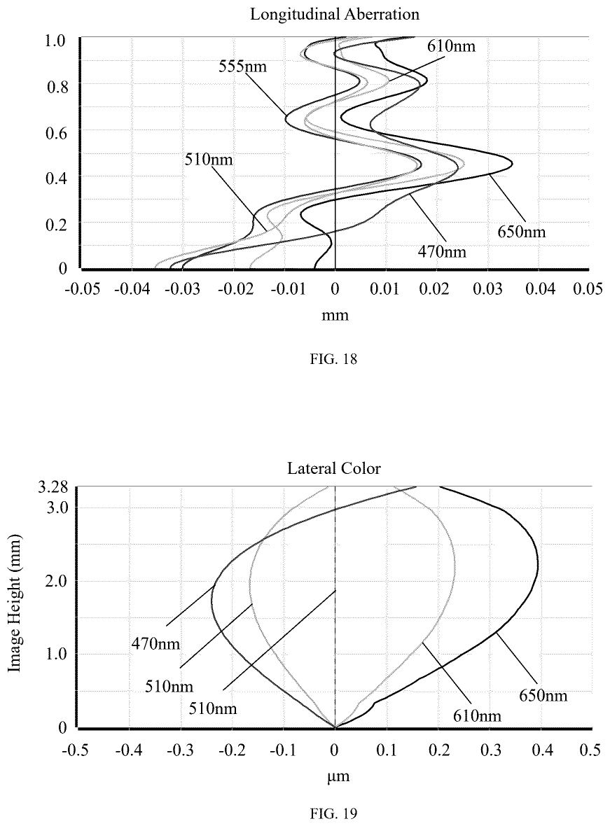

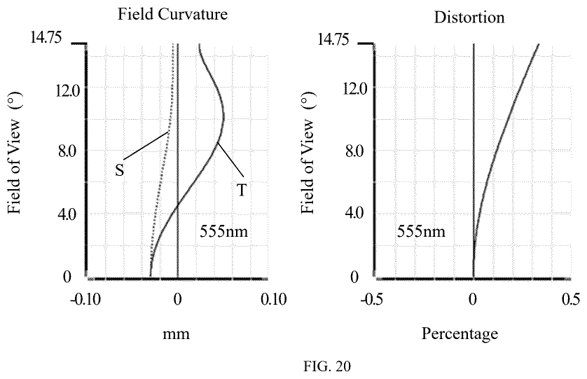

FIG. 18 and FIG. 19 respectively show longitudinal aberration and lateral color of the light at wavelengths of 650 nm, 610 nm, 555 nm, 510 nm and 470 nm after passing through the camera optical lens 40 according to the fourth embodiment. FIG. 20 shows field curvature and distortion of the light at a wavelength of 555 nm after passing through the camera optical lens 40 according to the fourth embodiment. In FIG. 20, the field curvature S is a field curvature in a sagittal direction, and T is a field curvature in a meridional direction.

In this embodiment, the entrance pupil diameter ENPD of the camera optical lens 40 is 4.282 mm, the image height IH at the 1.0 field of view is 3.277 mm, the field of view FOV at the 1.0 field of view is 29.50°, the image height IHm at the MIC field of view is 3.300 mm, and the field of view FOVm at the MIC field of view is 29.69°. The camera optical lens 40 meets the design requirements of long focus and miniaturization, effectively correcting both the on-axis and off-axis chromatic aberrations thereof, and has excellent optical characteristics.

Table 21 appearing hereafter shows values of various values in the first, second and third embodiments corresponding to parameters specified in the relational expressions.

### Comparative Embodiment

The meaning of the reference signs of the comparative embodiment is the same as that of the first embodiment.

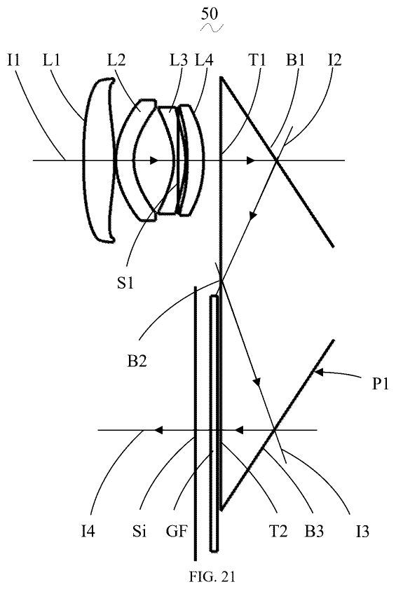

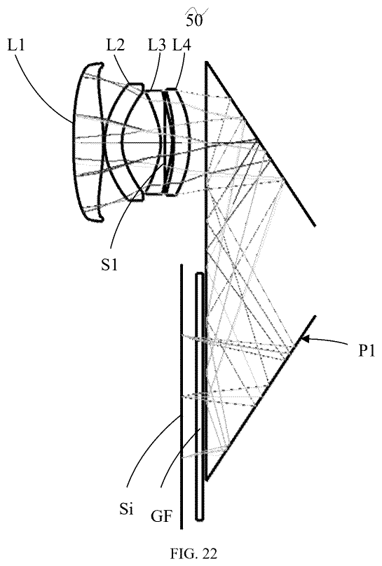

FIG. 21 shows a camera optical lens 50 according to the comparative embodiment.

Table 9 and Table 10 show design data of the camera optical lens 50 according to the comparative embodiment.

TABLE 9

| | R | d | | nd | | vd | |
|---|---|---|---|---|---|---|---|
| S1 | ∞ | d0= | −2.927 | | | | |
| R1 | 16.363 | d1= | 0.963 | nd1 | 1.5444 | vd1 | 55.82 |
| R2 | −6.179 | d2= | 0.038 | | | | |
| R3 | 2.127 | d3= | 0.556 | nd2 | 1.6610 | vd2 | 20.53 |
| R4 | 1.660 | d4= | 1.243 | | | | |
| R5 | −1.897 | d5= | 0.363 | nd3 | 1.6610 | vd3 | 20.53 |
| R6 | −2.735 | d6= | 0.052 | | | | |
| R7 | −10.263 | d7= | 0.504 | nd4 | 1.5444 | vd4 | 55.82 |
| R8 | −4.133 | d8= | 0.534 | | | | |
| R9 | ∞ | d9= | 1.754 | nd5 | 1.5688 | vd5 | 56.06 |
| R10 | ∞ | d10= | 4.446 | | | | |
| R11 | ∞ | d11= | 4.446 | | | | |
| R12 | ∞ | d12= | 1.754 | | | | |
| R13 | ∞ | d13= | 0.100 | | | | |
| R14 | ∞ | d14= | 0.210 | ndg | 1.5168 | vdg | 64.17 |
| R15 | ∞ | d15= | 0.480 | | | | |

Table 10 shows aspheric data of each lens in the camera optical lens 50 according to the comparative embodiment.

TABLE 10

| | Conic | | | | | |
|---|---|---|---|---|---|---|
| | Coefficient | Aspheric Coefficient | | | | |
| | k | A4 | A6 | A8 | A10 | A12 |
| R1 | −4.9803E+00 | 1.1323E−02 | −1.9789E−02 | 5.2457E−02 | −8.3439E−02 | 8.3681E−02 |
| R2 | 6.1943E−02 | −3.5650E−02 | 1.8138E−01 | −3.2249E−01 | 3.4640E−01 | −2.4665E−01 |
| R3 | −2.4868E+00 | −3.9903E−02 | 1.3353E−01 | −1.5639E−01 | 2.8703E−02 | 1.4220E−01 |
| R4 | −2.0616E+00 | −5.6698E−03 | −7.8653E−02 | 4.7082E−01 | −1.2642E+00 | 2.0293E+00 |
| R5 | −3.2702E+00 | −6.5844E−03 | 1.1414E−01 | −2.8567E−01 | 4.3502E−01 | −4.3907E−01 |
| R6 | 2.5606E−01 | −4.2029E−02 | 3.6903E−01 | −8.9254E−01 | 1.4207E+00 | −1.5412E+00 |
| R7 | 8.5589E+00 | −1.1894E−01 | 4.0293E−01 | −1.0856E+00 | 2.0762E+00 | −2.8232E+00 |
| R8 | −6.3241E+00 | −2.3975E−02 | −2.7395E−03 | −1.0482E−04 | 1.7866E−02 | −3.0321E−02 |
| | Conic | | | | | |
| | Coefficient | Aspheric Coefficient | | | | |
| | k | A14 | A16 | A18 | A20 | A22 |
| R1 | −4.9803E+00 | −5.6006E−02 | 2.5868E−02 | −8.3676E−03 | 1.8920E−03 | −2.9297E−04 |
| R2 | 6.1943E−02 | 1.2129E−01 | −4.1883E−02 | 1.0143E−02 | −1.6871E−03 | 1.8355E−04 |
| R3 | −2.4868E+00 | −1.9766E−01 | 1.3727E−01 | −5.9017E−02 | 1.6363E−02 | −2.8600E−03 |
| R4 | −2.0616E+00 | −2.1232E+00 | 1.5024E+00 | −7.2607E−01 | 2.3640E−01 | −4.9607E−02 |
| R5 | −3.2702E+00 | 2.9347E−01 | −1.2765E−01 | 3.4635E−02 | −5.3172E−03 | 3.5279E−04 |
| R6 | 2.5606E−01 | 1.1366E+00 | −5.6612E−01 | 1.8742E−01 | −3.9603E−02 | 4.8510E−03 |
| R7 | 8.5589E+00 | 2.7622E+00 | −1.9793E+00 | 1.0502E+00 | −4.1031E−01 | 1.1484E−01 |
| R8 | −6.3241E+00 | 2.3351E−02 | −9.4360E−03 | 1.9493E−03 | −1.6285E−04 | −3.5400E−09 |

| | Conic | | | | | |
|---|---|---|---|---|---|---|
| | Coefficient | Aspheric Coefficient | | | | |
| | k | A24 | A26 | A28 | A30 | / |
| R1 | −4.9803E+00 | 2.9598E−05 | −1.7572E−06 | 4.6486E−08 | −1.4864E−14 | / |
| R2 | 6.1943E−02 | −1.1759E−05 | 3.3619E−07 | −1.6840E−13 | −3.6277E−14 | / |
| R3 | −2.4868E+00 | 2.8754E−04 | −1.2701E−05 | 4.8017E−13 | 9.7516E−13 | / |
| R4 | −2.0616E+00 | 6.0579E−03 | −3.2692E−04 | 7.4729E−10 | 3.0969E−10 | / |
| R5 | −3.2702E+00 | 1.1359E−09 | 7.1445E−10 | 4.8744E−10 | 2.9702E−10 | / |
| R6 | 2.5606E−01 | −2.6319E−04 | −9.6000E−11 | −5.2202E−11 | −8.4385E−12 | / |
| R7 | 8.5589E+00 | −2.1743E−02 | 2.4871E−03 | −1.2948E−04 | −6.0293E−11 | / |
| R8 | −6.3241E+00 | −7.4928E−10 | −8.8868E−11 | 2.9410E−11 | 3.0522E−11 | / |

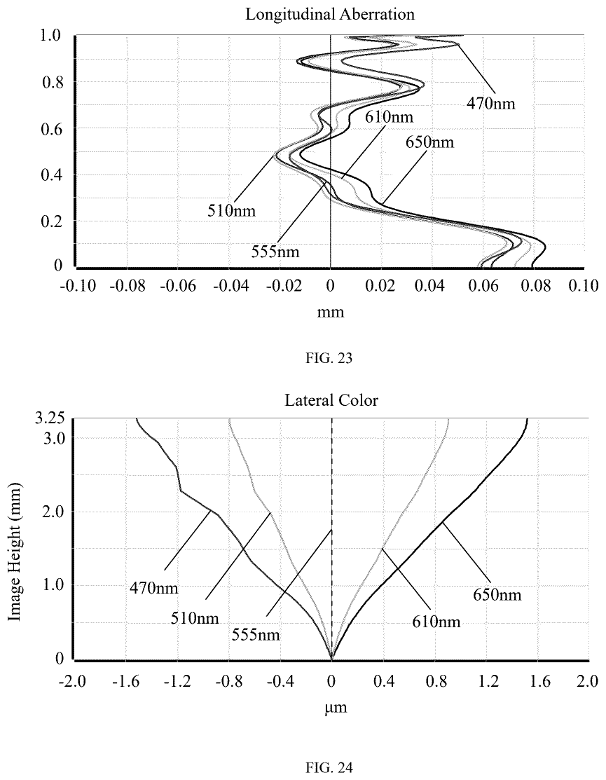

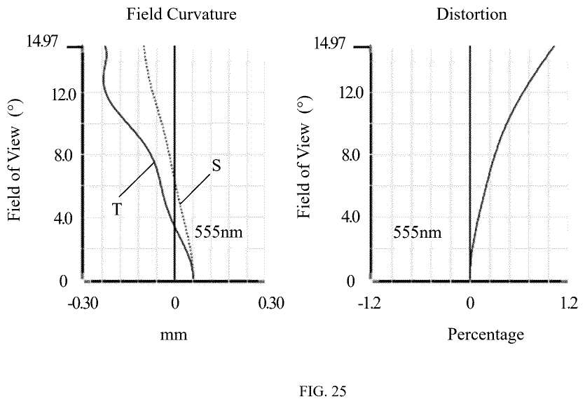

FIG. 23 and FIG. 24 respectively show longitudinal aberration and lateral color of the light at wavelengths of 650 nm, 610 nm, 555 nm, 510 nm and 470 nm after passing through the camera optical lens 50 according to the comparative embodiment. FIG. 25 shows field curvature and distortion of the light at a wavelength of 555 nm after passing through the camera optical lens 50 according to the comparative embodiment. In FIG. 25, the field curvature S is a field curvature in a sagittal direction, and T is a field curvature in a meridian direction.

In the comparative embodiment, the entrance pupil diameter ENPD of the camera optical lens 50 is 4.196 mm, the image height IH at the 1.0 field of view is 3.252 mm, the field of view FOV at the 1.0 field of view is 29.96°, the image height IHm at the MIC field of view is 3.282 mm, and the field of view FOVm at the MIC field of view is 30.22°.

Table 11 below lists values corresponding to each relational expression in the comparative embodiment according to the above relational expressions. It is apparent that, the value of Td/TTL of the camera optical lens 50 in the comparative embodiment is 0.213, which does not satisfy the relational expression 0.16≤Td/TTL≤0.21. Therefore, various aberrations of the camera optical lens 50 in the comparative embodiment have not been fully corrected, and the camera optical lens 50 does not have excellent optical characteristics.

TABLE 11

| Parameters | | | | | |
|---|---|---|---|---|---|
| and Relational | | | | | Comparative |
| expression | Embodiment 1 | Embodiment 2 | Embodiment 3 | Embodiment 4 | Embodiment |
| Td/TTL | 0.203 | 0.164 | 0.206 | 0.164 | 0.213 |
| f1/f | 0.687 | 0.315 | 0.697 | 0.321 | 0.688 |
| f12/f234 | −0.448 | −1.382 | −0.426 | −1.241 | −0.420 |
| d5/ET3 | 0.652 | 0.501 | 0.644 | 0.510 | 0.650 |
| R1/R2 | −2.717 | −1.268 | −2.997 | −1.008 | −2.648 |
| d5/d7 | 0.748 | 0.784 | 0.701 | 0.777 | 0.720 |
| (R1 − R2)/f1 | 2.741 | 3.183 | 2.877 | 3.150 | 2.704 |
| ET3 | 0.486 | 0.697 | 0.480 | 0.759 | 0.559 |
| f | 12.187 | 11.970 | 12.044 | 12.375 | 12.127 |
| f1 | 8.371 | 3.773 | 8.392 | 3.973 | 8.338 |
| f2 | −22.779 | −7.062 | −23.254 | −8.881 | −21.681 |
| f3 | −10.879 | −5.042 | −10.757 | −5.126 | −11.240 |
| f4 | 12.384 | 8.680 | 12.159 | 10.472 | 12.309 |
| FNO | 2.890 | 2.890 | 2.890 | 2.890 | 2.890 |
| TTL | 17.222 | 16.705 | 17.076 | 16.644 | 17.443 |
| IH | 3.277 | 3.277 | 3.277 | 3.277 | 3.252 |
| FOV | 29.81° | 30.48° | 30.15° | 29.50° | 29.96° |

Those skilled in the art should understand that the above embodiments are just specific embodiments for implementing the present disclosure, and in practical applications, various changes may be implemented in form and detail without departing from the spirit and scope of the present disclosure.

What is claimed is:

1. A camera optical lens, comprising from an object side to an image side:
a first lens having a positive refractive power;
a second lens having a negative refractive power;
a third lens having a negative refractive power;
a fourth lens having a positive refractive power; and
a prism having a reflective power,
wherein the prism comprises along an optical axis: a first transmissive surface, a first reflective surface, a second reflective surface, a third reflective surface and a second transmissive surface, wherein the first transmissive surface, the second reflective surface and the second transmissive surface are parallel to each other, and
wherein a focal length of the camera optical lens is f, a focal length of the first lens is f1, a combined focal length of the first lens and the second lens is f12, a combined focal length of the second lens, the third lens and the fourth lens is f234, a central curvature radius of an object side surface of the first lens is R1, a central curvature radius of an image side surface of the first lens is R2, an on-axis thickness of the third lens is d5, a distance from a maximum effective aperture of an object side surface of the third lens to a maximum effective aperture of an image side surface of the third lens in a direction parallel to the optical axis is ET3, an on-axis distance from the object side surface of the first lens to an image side surface of the fourth lens is Td, a total track length of the camera optical lens is TTL, and following relational expressions are satisfied:
$$0.3 \leq f 1 / f \leq 0.7 ;$$
$$- 1.4 \leq f 12 / f 2 \; 34 \leq - 0.426 ;$$
$$- 3. \leq R 1 / R 2 \leq - 1. ;$$
$$0.16 \leq Td / TTL \leq 0.21 ; and$$
$$0.05 \leq d 5 / ET 3 \leq 0.66 .$$

2. The camera optical lens as described in claim 1, wherein an on-axis thickness of the fourth lens is d7, and a following relational expression is satisfied:
$$0.7 \leq d 5 / d 7 \leq 0.80 .$$

3. The camera optical lens as described in claim 1, wherein the camera optical lens satisfies a following relational expression:
$$2.7 \leq ( R 1 - R 2 ) / f 1 \leq 3.2 .$$

4. The camera optical lens as described in claim 1, wherein the object side surface of the first lens is convex in a paraxial region, and the image side surface of the first lens is convex in the paraxial region, and
wherein an on-axis thickness of the first lens is d1, and a following relational expression is satisfied:
$$0.046 \leq d 1 / TTL \leq 0.051 .$$

5. The camera optical lens as described in claim 1, wherein an image side surface of the second lens is concave in a paraxial region, and
wherein a focal length of the second lens is f2, a central curvature radius of an object side surface of the second lens is R3, a central curvature radius of the image side surface of the second lens is R4, and an on-axis thickness of the second lens is d3, and following relational expressions are satisfied:
$$- 1.94 \leq f 2 / f \leq - 0.58 ;$$
$$- 0.6 \; 8 \leq ( R 3 + R 4 ) / ( R 3 - R 4 ) \leq 8.29 ; and$$
$$0.016 \leq d 3 / TTL \leq 0.034 .$$

6. The camera optical lens as described in claim 1, wherein
a focal length of the third lens is f3, a central curvature radius of the object side surface of the third lens is R5, and a central curvature radius of the image side surface of the third lens is R6, and following relational expressions are satisfied:
$$- 0.90 \leq f 3 / f \leq - 0.41 ;$$
$$- 5.5 \; 1 \leq ( R 5 + R 6 ) / ( R 5 - R 6 ) \leq 1.34 ; and$$
$$0.018 \leq d 5 / TTL \leq 0.024 .$$

7. The camera optical lens as described in claim 1, wherein the image side surface of the fourth lens is convex in a paraxial region, and
wherein a focal length of the fourth lens is f4, a central curvature radius of an object side surface of the fourth lens is R7, a central curvature radius of the image side surface of the fourth lens is R8, and an on-axis thickness of the fourth lens is d7, and following relational expressions are satisfied:
$$0.72 \leq f 4 / f \leq 1.02 ;$$
$$0.97 \leq ( R 7 + R 8 ) / ( R 7 - R 8 ) \leq 2.39 ; and$$
$$0.024 \leq d 7 / TTL \leq 0.030 .$$

8. The camera optical lens as described in claim 1, wherein a ratio of a focal length of the camera optical lens to an entrance pupil diameter is FNO, and a following relational expressions is satisfied:
$$FNO \leq 2.9 .$$

9. The camera optical lens as described in claim 1, wherein an image height of the camera optical lens is IH, and a following relational expression is satisfied:
$$TTL / IH \leq 5.26 .$$

10. The camera optical lens as described in claim 1, wherein the prism and/or the first lens are made of glass.
